(19) United States
(12) Patent Application Publication
(10) Pub. No.: US 2026/0004792 A1
(43) Pub. Date: Jan. 1, 2026

(54) METHODS OF FIXED CODEBOOK SEARCHING FOR AUDIO CODECS

(71) Applicant: WhatsApp, LLC, Menlo Park, CA (US)

(72) Inventors: Jatin Kumar, Mountain View, CA (US); Bikash K. Agarwalla, Los Altos, CA (US); Sriram Srinivasan, Sammamish, WA (US); King Wei Hor, Redmond, WA (US); Koen Bernard Vos, Singapore (SG); Nicholas Warren Lenz, Santa Clara, CA (US); Henrik Julius Åström, Solna (SE); Soeren Skak Jensen, Seattle, WA (US)

(73) Assignee: WhatsApp, LLC, Menlo Park, CA (US)

(21) Appl. No.: 19/252,840

(22) Filed: Jun. 27, 2025

Related U.S. Application Data
(60) Provisional application No. 63/666,601, filed on Jul. 1, 2024.

(51) Int. Cl. G10L 19/12; G10L 19/00; G10L 25/21

(52) U.S. Cl. CPC G10L 19/12; G10L 25/21; G10L 2019/0013

(57) ABSTRACT

Methods and systems are described for encoding voice speech. A method may include receiving, by an audio encoder, an audio signal comprising a plurality of subframes; determining, for a first subframe of the plurality of subframes, a number of fixed codebook (FCB) pulses according to a rate distortion criteria; selecting, in the subframe, a first set of one or more FCB pulses across a time domain and according to the determined number of FCB pulses; and generating a FCB signal based on the selected first set of FCB pulses.

### CROSS-REFERENCE TO RELATED APPLICATION

This application claims the benefit of U.S. Application No. 63/666,601, filed Jul. 1, 2024, the entirety of which is hereby incorporated by reference.

### TECHNICAL FIELD

Examples of the present disclosure relate generally to methods, apparatuses, and computer program products for fixed codebook searching of candidate pulses for audio codecs.

### BACKGROUND

The fixed codebook (FCB) for audio codecs, such as those implementing Codebook Excited Linear Prediction (CELP), typically represent signal subframes as a zero signal, except for a limited number of pulses. The pulses can be signed (e.g., positive, negative), stackable (e.g., more than one pulse for a given sample), and are scaled by a gain value. The encoder side of the codec may attempt to generate a FCB signal that is minimally distorted as measured by the weighted error (e.g., in relation to the linear predictive coding (LPC) signal with the adaptive codebook (ACB) signal removed (LPC-ACB)).

Conventional CELP encoders expend a significant amount of computational resources determining locations for the FCB pulses. As the number of pulses in a given subframe increases, the computational resources required to identify the FCB signal increases exponentially and becomes unfeasible. However, decreasing the number of pulses for a FCB signal may introduce additional error into the signal, which may result in a lower quality signal output. There exists a need for FCB methods for FCB pulse searching that optimizes error values and computational resources.

### BRIEF SUMMARY

Methods and systems are described for fixed codebook (FCB) searching for Codebook Excited Linear Prediction (CELP) audio codecs. A method may include receiving, by an audio encoder, an audio signal comprising a plurality of subframes; determining, for a first subframe of the plurality of subframes, a number of fixed codebook (FCB) pulses according to a rate distortion criteria; selecting, in the subframe, a first set of one or more FCB pulses across a time domain and according to the determined number of FCB pulses; and generating a FCB signal based on the selected first set of FCB pulses.

Additional advantages will be set forth in part in the description which follows or may be learned by practice. The advantages will be realized and attainted by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1 illustrates a diagram of an exemplary network environment in accordance with one or more example aspects of the subject technology.

FIG. 2 illustrates a diagram of an exemplary communication device in accordance with one or more example aspects of the subject technology.

FIG. 3 illustrates an exemplary computing system in accordance with one or more example aspects of the subject technology.

FIG. 4 illustrates a machine learning and training model framework in accordance with example aspects of the present disclosure.

FIG. 5 illustrates a system for in accordance with one or more example aspects of the subject technology.

FIGS. 6A-6F illustrates speech waveforms in accordance with one or more example aspects the subject technology.

FIG. 7 illustrates a ratio-distortion optimization graph in accordance with one or more example aspects the subject technology.

FIGS. 8-10 illustrates processes in accordance with one or more example aspects of the subject technology.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the subject technology will now be described more fully hereinafter with reference to the accompanying drawings, in which some, but not all examples of the subject technology are shown. Indeed, various examples of the subject technology may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

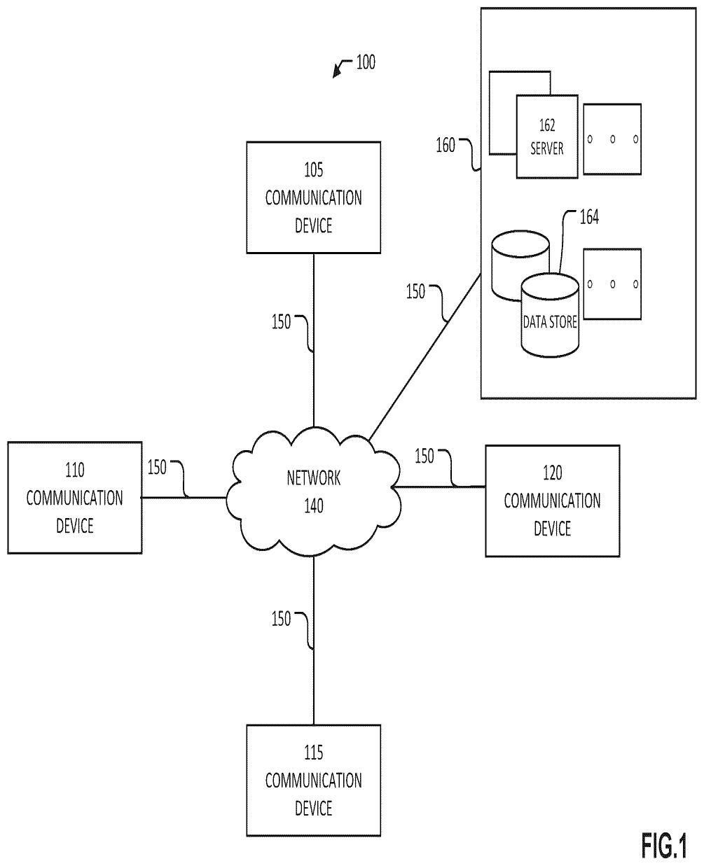

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140. In other examples, the network 140 may be any suitable network capable of provisioning content and/or facilitating communications among entities within, or associated with the network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

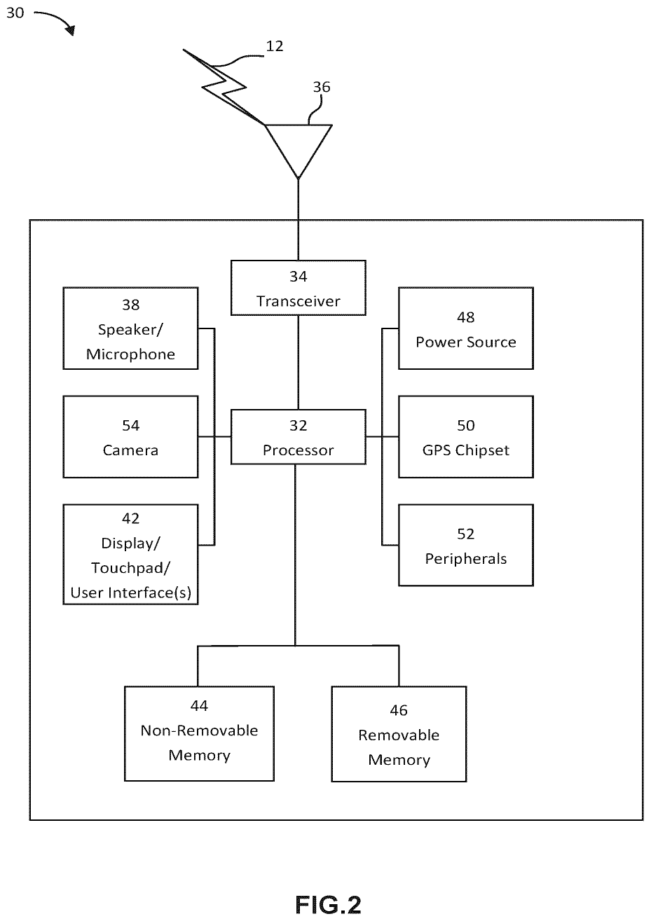

FIG. 2 illustrates a block diagram of an exemplary hardware/software architecture of a communication device such as, for example, user equipment (UE) 30. In some exemplary respects, the UE 30 may be any of communication devices 105, 110, 115, 120. In some exemplary aspects, the UE 30 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a display, touchpad, and/or user interface(s) 42, a power source 48, a GPS chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptacle and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example. The non-removable memory 44 and/or the removable memory 46 may be computer-readable storage mediums. For example, the non-removable memory 44 may include a non-transitory computer-readable storage medium and a transitory computer-readable storage medium.

The processor 32 is coupled to its communication circuitry (e.g., transceiver 34 and transmit/receive element 36). The processor 32, through the execution of computer-executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

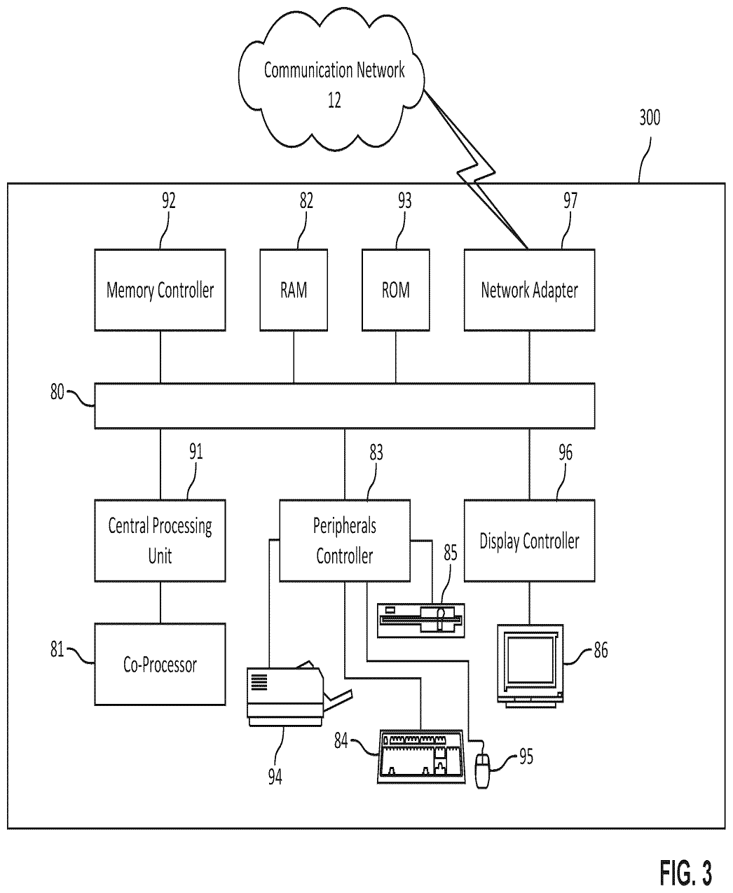

FIG. 3 is a block diagram of an exemplary computing system 300. In some exemplary embodiments, the network device 160 may be a computing system 300. The computing system 300 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adapter 97, that may be used to connect computing system 300 to an external communications network, such as network 12 of FIG. 2, to enable the computing system 300 to communicate with other nodes (e.g., UE 30) of the network.

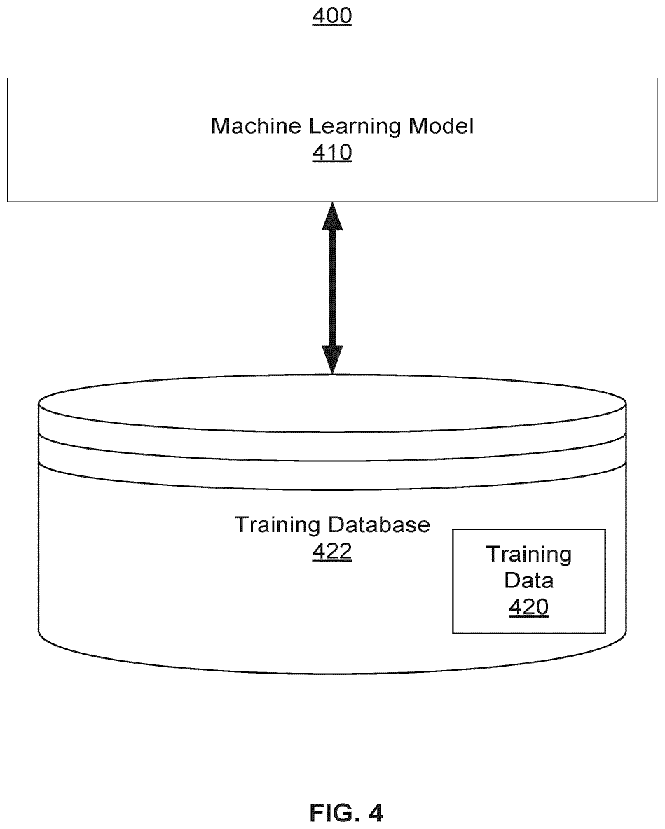

FIG. 4 illustrates a machine learning and training model, in accordance with an example of the present disclosure. The machine learning framework 400 associated with the machine learning model may be hosted remotely. Alternatively, the machine learning framework 400 may reside within a server 162 shown in FIG. 1, or be processed by an electronic device (e.g., head mounted displays, smartphones, tablets, smartwatches, or any electronic device, such as communication device 105). The machine learning model 410 may be communicatively coupled to the stored training data 420 in a memory or database (e.g., ROM, RAM) such as training database 422. In some examples, the machine learning model 410 may be associated with operations of any one or more of the systems/architectures depicted in subsequent figures of the application. In some other examples, the machine learning model 410 may be associated with other operations. The machine learning model 410 may be implemented by one or more machine learning models(s) and/or another device (e.g., a server and/or a computing system). In some embodiments, the machine learning model 410 may be a student model trained by a teacher model, and the teacher model may be included in the training database 422.

### Audio Coding

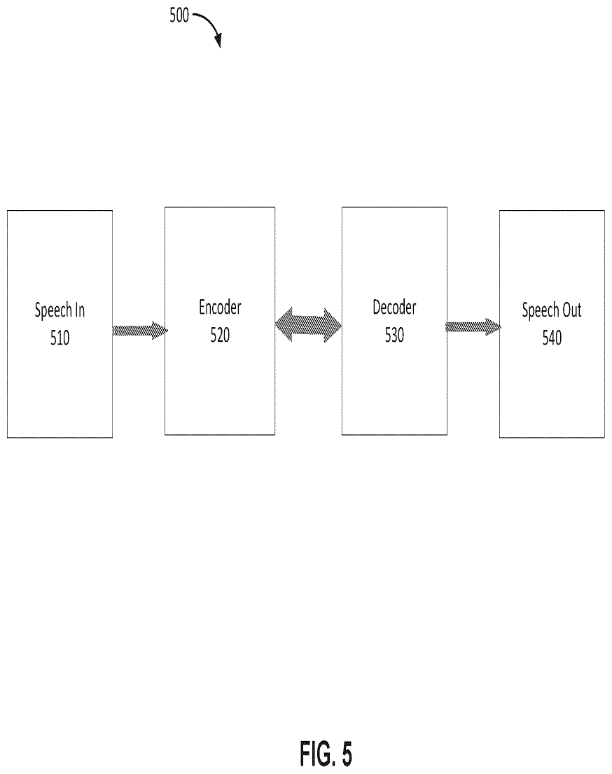

According to an aspect of the present application, audio coding (e.g., speech coding, music signal coding, or other type of audio coding) can be performed on a digitized audio signal (e.g., a speech signal) to compress the amount of data for storage, transmission, and/or other use. FIG. 5 is a block diagram illustrating an example of a voice coding system 500 (which can also be referred to as a voice or speech coder or a voice coder-decoder (codec)). Voice coding system 500 may be operably coupled to the communications device of FIG. 2 or the communication system of FIG. 3. A voice encoder 520 of the voice coding system 500 may use a voice coding algorithm to process a speech signal 510.

The speech signal 510 may include a digitized speech signal generated from an analog speech signal of a given source. For instance, the digitized speech signal can be generated using a filter to eliminate aliasing, a sampler to convert to discrete-time, and an analog-to-digital converter for converting the analog signal to the digital domain. The resulting digitized speech signal (e.g., speech signal 510) is a discrete-time speech signal with sample values (referred to herein as samples) that are also discretized.

Voice coders can exploit the fact that speech signals are highly correlated waveforms. The samples of an input speech signal can be divided into blocks of N samples each, where a block of N samples is referred to as a frame. In one illustrative example, each frame can be 10-20 milliseconds (ms) in length.

By using a voice coding algorithm, the voice encoder 520 can generate a compressed signal (including a lower bit-rate stream of data) that represents speech signal 510 using as few bits as possible. This may also be performed while attempting to maintain a certain quality level for the speech. The voice encoder 520 can use any suitable voice coding algorithm, such as a linear prediction coding algorithm (e.g., Code-excited linear prediction (CELP), algebraic-CELP (ACELP), or other linear prediction technique) or other voice coding algorithm.

CELP models are widely used in digital communication systems, such as mobile phones, VoIP applications, and audio streaming services, due to their efficiency in compressing speech while maintaining high audio quality. The CELP model is based on a source-filter model of speech production, which assumes that the vocal cords are the source of spectrally flat sound (an excitation signal), and that the vocal tract acts as a filter to spectrally shape the various sounds of speech. The different phonemes (e.g., vowels, fricatives, and voice fricatives) can be distinguished by their excitation (source) and spectral shape (filter).

In general, CELP uses LPC to model the speech signal as a linear combination of past samples. In LPC, the speech signal is divided into frames, and each frame is modeled as a linear combination of past samples. The LPC coefficients are used to predict the current sample based on the past samples. The prediction error is then quantized and transmitted or stored. The LPC coefficients can be transmitted or stored as well, but they typically require more bits than the prediction error. To capture the spectral envelope of the speech signal, LPC coefficients are generally combined with a codebook. The codebook contains a set of spectral shapes, and LPC coefficients are used to select the best spectral shape for each frame.

Referring again to FIG. 5, the voice encoder 520 may attempt to reduce the bit-rate of the speech signal 101. The bit-rate of a signal is based on the sampling frequency and the number of bits per sample. For instance, the bit-rate of a speech signal can be determined as follows: BR=S*b, where BR is the bit-rate, S is the sampling frequency, and b is the number of bits per sample. In one illustrative example, at a sampling frequency(S) of 8 kilohertz (kHz) and at 16 bits per sample (b), the bit-rate of a signal would be a bit-rate of 128 kilobits per second (kbps).

The compressed speech signal may be transmitted to and processed by a voice decoder 530. In some examples, the voice decoder 530 can communicate with the voice encoder 520, such as to request speech data, send feedback information, and/or provide other communications to the voice encoder 520. In some examples, the voice encoder 520 or a channel encoder can perform channel coding on the compressed speech signal before the compressed speech signal is sent to the voice decoder 530. For instance, channel coding can provide error protection to the bitstream of the compressed speech signal to protect the bitstream from noise and/or interference that can occur during transmission on a communication channel.

The voice decoder 530 decodes the data of the compressed speech signal and constructs a reconstructed speech signal 540 that approximates the original speech signal 510. The reconstructed speech signal 540 includes a digitized, discrete-time signal that can have the same bit-rate as that of the original speech signal 510. The voice decoder 530 can use an inverse of the voice coding algorithm used by the voice encoder 520. In some cases, the reconstructed speech signal 540 can be converted to continuous-time analog signal, such as by performing digital-to-analog conversion and anti-aliasing filtering.

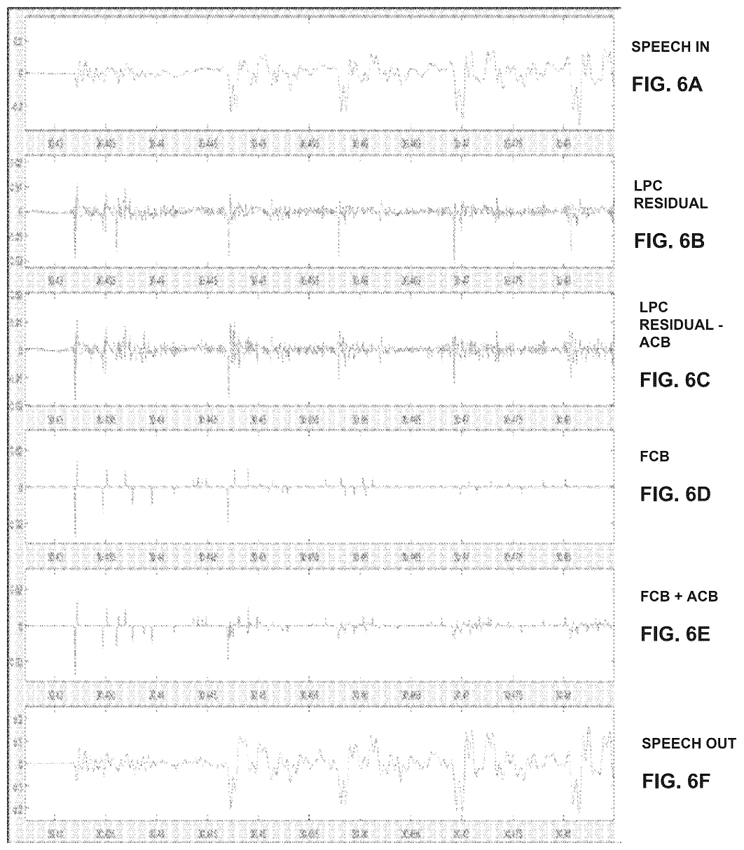

According to a further embodiment of this aspect, FIGS. 6A-D exemplarily describe functionality at the encoder 520. Meanwhile FIGS. 6E-F describe functionality at the decoder 530. As depicted in FIG. 6A, an original input speech signal is received at encoder 520 for compression and transmission to decoder 530. FIG. 6B illustrates a speech signal after an LPC analysis returning an LPC residual signal and LPC coefficients. The obtained LPC coefficients are subsequently sent to a decoder.

Moreover, FIG. 6C illustrates further processing of the LPC residual signal with ACB (e.g., assuming voiced speech). The ACB uses information from the last few frames to find a best match based on the sound characteristics of the current speaker. As depicted in FIG. 6C, ACB is further subtracted from the LPC residual to locate a best match in the FCB.

FIG. 6D illustrates the FCB signal including locations of plural pulses. The pulses exhibit different magnitudes. When the pulses are passed through LPC synthesis, an output similar to the residual signal is obtained.

As shown in FIG. 6E, the decoder 530, may receive the FCB search results as FCB indexes and a separate set of ACB coefficients. Decoder 530 extracts these quantized coefficients and initiates construction of signal. In so doing, the decoder 530 adds the FCB and ACB (e.g., reversing what the encoder performed). The output depicted is passed through LPC synthesis using the LPC coefficients derived in FIG. 6A.

As depicted in FIG. 6F, the resulting speech out signal constructed by the decoder 530 is obtained. The speech out signal may be ready for transmission to another entity or alternatively transmitted to another device for subsequent processing. As will be evident upon comparison, the speech out signal illustrated in FIG. 6F appears similar to the speech in signal illustrated in FIG. 6A.

### Speech Encoding

According to an aspect of the application, the subject technology describes a method and architecture for decoding speech. It is envisaged the subject technology may decode and generate speech signals with one or more different: (i) characteristics, such as male or female voices, or different accents or emotions; (ii) languages or dialects, making it suitable for use in multilingual environments; prosodic features, such as intonation, stress, and rhythm; (iii) levels of expressiveness, making it suitable for use in various applications, such as storytelling or acting; (iv) levels of naturalness, making it suitable for use in various applications, such as voice acting or audiobooks; and (v) levels of clarity, making it suitable for use in various applications, such as public speaking or voiceover.

The subject technology is particularly useful for applications where low bit rate and low-frequency speech transmission is necessary, such as in mobile or remote communication devices. A bit rate of the transmitted speech may be less than 15 Kb per second, and the frequency may be less than 8 kHz. The subject technology may be implemented using a variety of hardware and software configurations, including dedicated decoding hardware or software running on a computing system as depicted in FIG. 3 or a communication device as depicted in FIG. 2. The method can also be used in conjunction with other speech processing techniques, such as noise reduction or speech enhancement, to further improve the quality of the decoded speech.

In an embodiment, by utilizing a trained ML model of the decoder, such as for example the ML model and training data depicted in FIG. 4, the methods and architectures may accurately decode encoded speech with a high degree of accuracy, even in noisy or low-quality environments. The decoder may be trained using a dataset of speech signals and corresponding encoded data. The method may be trained using a variety of data sources. These may include for example recorded speech samples or synthetic speech generated using text-to-speech algorithms. The training may also involve optimizing the decoder's parameters to minimize the difference between the decoded speech signals and the original speech signals. The trained ML model of the decoder may be periodically updated or retrained to improve its accuracy and adapt to changing speech patterns or environments.

In a further embodiment, the method may use one or more of FCB and ACB to generate the excitation signal. The FCB contains pre-defined codewords that are used to represent certain speech sounds. The ACB contains codewords that are selected based on the characteristics of the speech signal being decoded.

According to an aspect of the subject technology, methods for selecting a number of pulses for an FCB signal are described in this application. The methods described herein can be implemented by an audio codec, such as the voice coding system 500 of FIG. 5.

Conventional CELP encoders/decoders (codecs) can allocate a predefined number of signal pulses to each subframe of speech signal. For example, each subframe can be a 5 ms subframe, and each subframe can be allocated 10 signal pulses for generating a FCB signal. According to the present disclosure, an audio codec can be a variable bitrate codec. The audio codec can facilitate variable signal pulses per frame or per subframe for generating a FCB signal.

The encoder of the audio codec, such as the voice encoder 520 of the voice coding system 500, can receive a speech signal, such as speech signal of FIG. 6A, which can be an example of speech signal 510 of FIG. 5. The encoder can process the speech signal and can generate a LPC residual signal of FIG. 6B. The encoder can further process the LPC residual signal to generate a LPC residual-ACB signal of FIG. 6C. The encoder can further process the LPC residual-ACB signal to generate the FCB signal of FIG. 6D. For generating the FCB signal of FIG. 6D, the encoder can select signal pulse locations of the LPC residual-ACB signal of FIG. 6C. The number of pulses selected for a given subframe can be according to a rate-distortion criteria. The number of pulses for a subframe can be selected to maximize:

$$Energy ( FCB ) / Energy ( Target ) - {Slope}_{RD} * Number\_of \_Pulses$$

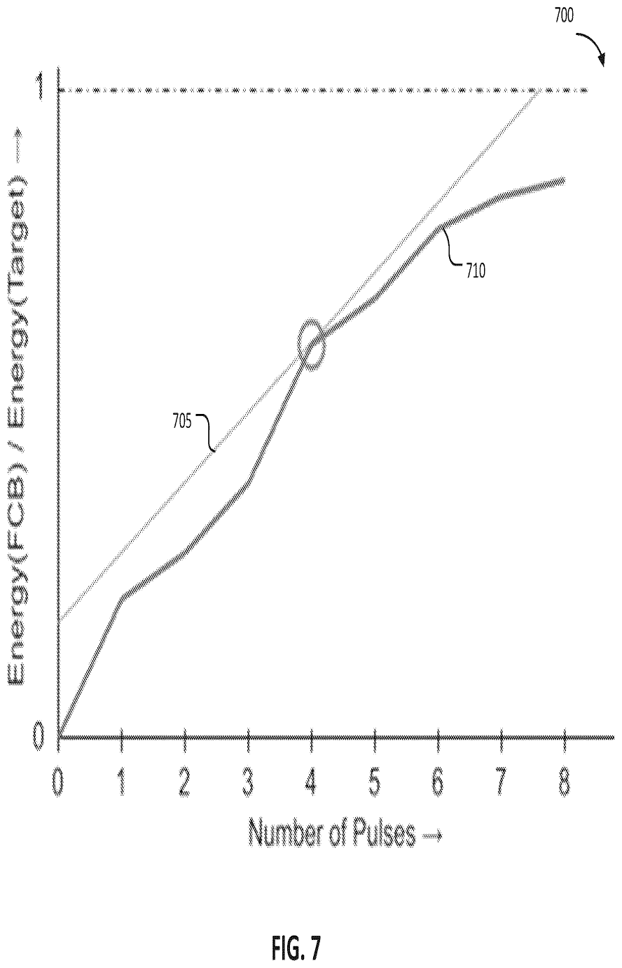

Energy(FCB) can be the energy of the weighted FCB contribution for a number of pulses in the subframe, Energy(Target) can be energy of the LPC residual-ACB signal of FIG. 6C, Slope_{RD} can be rate-distortion parameter, and Number_of_Pulses can be the selected number of pulses for the subframe. FIG. 7 shows a graph 700 illustrating the rate-distortion optimization. The function 705 can be the slope_{RD}, and the function 710 can be the Energy(FCB)/Energy(Target). In the example of FIG. 7, the optimal number of pulses for the subframe is 4 pulses.

To distribute pulses across subframes, slope_{RD} can be varied. For example, to maximize the SNR for the frame, slope_{RD} can be made proportional to the inverse of Energy(Target). Additionally, in some cases slope_{RD} can be:

$${slope}_{RD} = const \cdot {( \frac{Smooth ( resnrg )}{resnrg} )}^{a} .$$

Where const can be on the target bitrate, resnrg can be the energy of the subframe's whitened (residual) speech energy, Smooth( ) can be an AR(1) smoother, and a can be a power between 0.5 and 1.0.

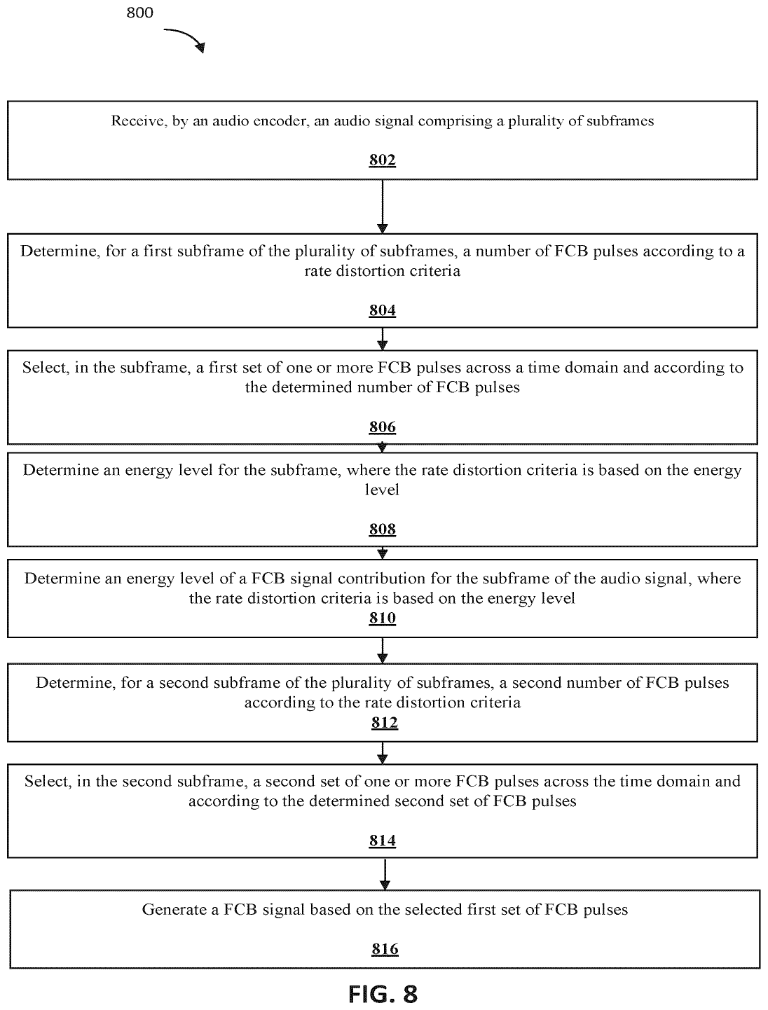

In another example embodiment of this aspect as depicted in FIG. 8, a flowchart is described of a process 800 for decoding voiced speech. In some implementations, one or more process blocks of FIG. 8 may be performed by a device.

As shown in FIG. 8, process may include receiving, by an audio encoder, an audio signal comprising a plurality of subframes (block 802). As also shown in FIG. 8, process 800 may include determining, for a first subframe of the plurality of subframes, a number of FCB pulses according to a rate distortion criteria (block 804). As also shown in FIG. 8, process 800 may include selecting, in the subframe, a first set of one or more FCB pulses across a time domain and according to the determined number of FCB pulses (block 806). As also shown in FIG. 8, process 800 may include determining an energy level for the subframe, where the rate distortion criteria is based on the energy level (block 808). As also shown in FIG. 8, process 800 may include determining an energy level of a FCB signal contribution for the subframe of the audio signal, where the rate distortion criteria is based on the energy level (block 810). As also shown in FIG. 8, process 800 may include determining, for a second subframe of the plurality of subframes, a second number of FCB pulses according to the rate distortion criteria (block 812). As also shown in FIG. 8, process 800 may include selecting, in the second subframe, a second set of one or more FCB pulses across the time domain and according to the determined second set of FCB pulses (block 814). As also shown in FIG. 8, process 800 may include generating a FCB signal based on the selected first set of FCB pulses (block 816).

Although FIG. 8 depicts example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

According to another aspect of the present disclosure, a method and architecture for FCB searching is described herein. In an embodiment, an audio encoder may position a pulse at a point in time. The encoder may determine a list of K candidates, where each candidate may include of a set of P pulse locations and signs (e.g., positive or negative). When adding the next pulse, P+1, the encoder may determine the best K pulse locations for each of the K candidates (e.g., by minimizing the weighted error). This may result in K² new candidates. The encoder may then select the K best of these before moving on to the next pulse. Once all pulses have been placed, the encoder may select the candidate with the lowest weighted error and incorporate the corresponding set of pulse locations for the FCB.

For this delayed-decision FCB search, the complexity may scale with the product of total number of pulses and number of candidates K. In order for the complexity to be independent of the number of pulses, a lower number K may be selected when encoding more pulses. To obtain finer granularity of the complexity, K candidates may be used for some pulses and K−1 candidates for other pulses.

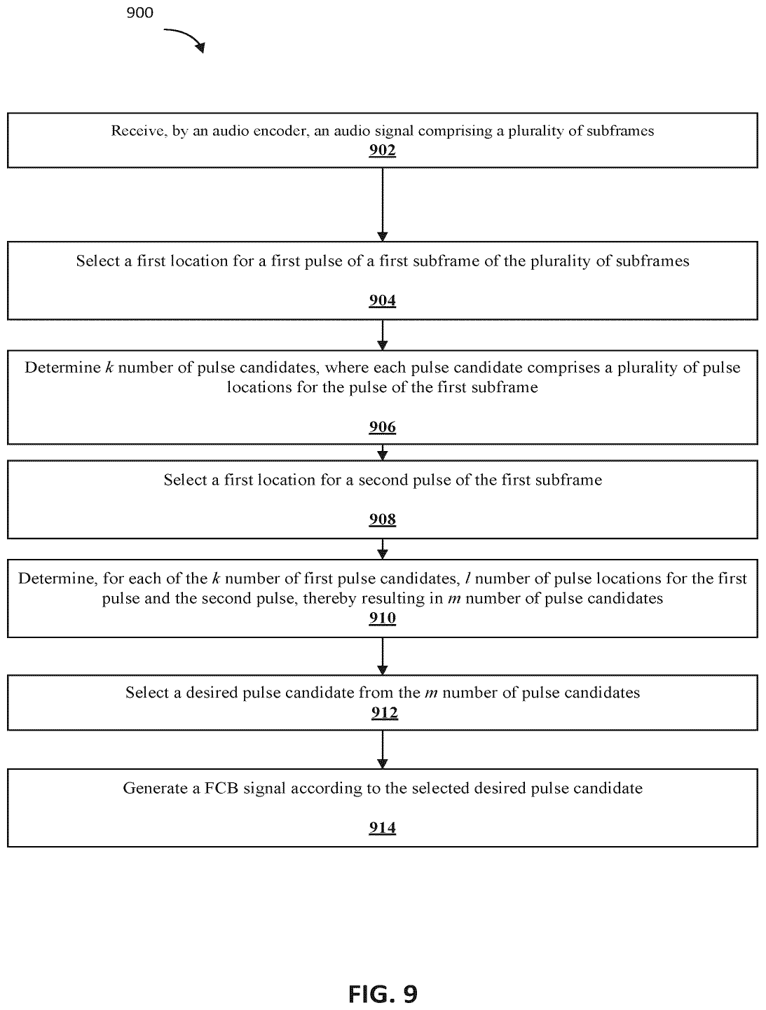

In another example embodiment of this aspect as depicted in FIG. 9, a flowchart is described of a process 900 for encoding voice speech. In some implementations, one or more process blocks of FIG. 9 may be performed by a device.

As shown in FIG. 9, process 900 may include receiving, by an audio encoder, an audio signal comprising a plurality of subframes (block 902). As also shown in FIG. 9, process 900 may include selecting a first location for a first pulse of a first subframe of the plurality of subframes (block 904). As also shown in FIG. 9, process 900 may include determining k number of pulse candidates, where each pulse candidate comprises a plurality of pulse locations for the pulse of the first subframe (block 906). As also shown in FIG. 9, process 900 may include selecting a first location for a second pulse of the first subframe (block 908). As also shown in FIG. 9, process 900 may include determining, for each of the k number of first pulse candidates, l number of pulse locations for the first pulse and the second pulse, thereby resulting in m number of pulse candidates (block 910). As also shown in FIG. 9, process 900 may include selecting a desired pulse candidate from the m number of pulse candidates (block 912). As also shown in FIG. 9, process 900 may include generating a FCB signal according to the selected desired pulse candidate (block 914).

Although FIG. 9 depicts example blocks of process 800, in some implementations, process 900 may include additional blocks, fewer blocks, different blocks, or differently arranged blocks than those depicted in FIG. 9. Additionally, or alternatively, two or more of the blocks of process 900 may be performed in parallel.

According to another aspect of the present disclosure, a method and architecture for FCB searching is described herein. In an embodiment, an audio encoder may assign to each pulse position, of a pulse candidate, a unique integer signature value. The encoder may combine the signature values for the pulse positions of each candidate. In some cases, the combining ma include an unsigned wrap-around combining. In some cases, the combining may be associative. Thus, two candidates with identical pulse positions may include the same signature sum, regardless of the ordering of pulse positions. The encoder may select one of the candidates and remove the selected candidate from the list of candidates moving forward. The removal may decrease the expenditure of processing resources of the encoder.

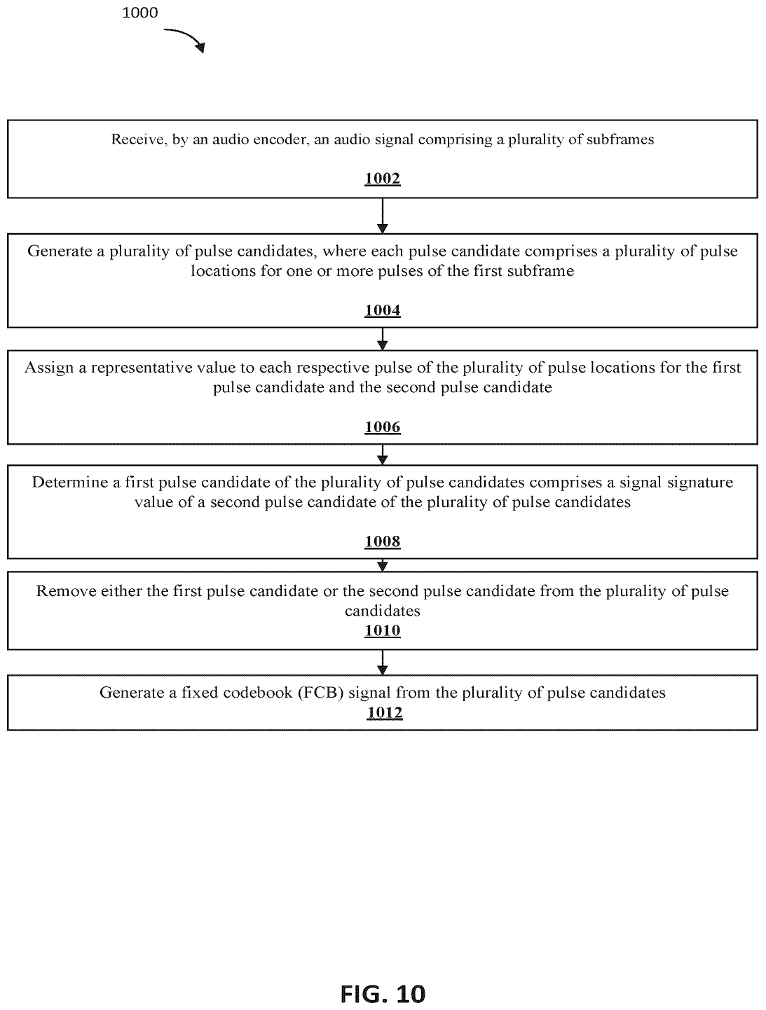

In another example embodiment of this aspect as depicted in FIG. 10, a flowchart is described of a process 1000 for encoding voice speech. In some implementations, one or more process blocks of FIG. 10 may be performed by a device.

As shown in FIG. 10, process 1000 may include receiving, by an audio encoder, an audio signal comprising a plurality of subframes (block 1002). As also shown in FIG. 10, process 1000 may include generating a plurality of pulse candidates, where each pulse candidate comprises a plurality of pulse locations for one or more pulses of the first subframe (block 1004). As also shown in FIG. 10, process 1000 may include assigning a representative value to each respective pulse of the plurality of pulse locations for the first pulse candidate and the second pulse candidate (block 1006). As also shown in FIG. 10, process 1000 may include determining a first pulse candidate of the plurality of pulse candidates comprises a signal signature value of a second pulse candidate of the plurality of pulse candidates (block 1008). As also shown in FIG. 10, process 1000 may include removing either the first pulse candidate or the second pulse candidate from the plurality of pulse candidates (block 1010). As also shown in FIG. 10, process 1000 may include generating a fixed codebook (FCB) signal from the plurality of pulse candidates (block 1012).

Although FIG. 10 depicts example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving, by an audio encoder, an audio signal comprising a plurality of subframes;
determining, for a first subframe of the plurality of subframes, a number of fixed codebook (FCB) pulses according to a rate distortion criteria;
selecting, in the subframe, a first set of one or more FCB pulses across a time domain and according to the determined number of FCB pulses; and
generating a FCB signal based on the selected first set of FCB pulses.

2. The method of claim 1, wherein the audio signal comprises a weighted residual audio signal, and the method further comprises:
determining an energy level for the subframe of the weighted residual audio signal, wherein the rate distortion criteria is based on the energy level.

3. The method of claim 1, wherein the audio signal comprises a weighted residual audio signal, and the method further comprises:
determining an energy level of a FCB signal contribution for the subframe of the audio signal, wherein the rate distortion criteria is based on the energy level.

4. The method of claim 1, further comprising:
determining, for a second subframe of the plurality of subframes, a second number of FCB pulses according to the rate distortion criteria;
selecting, in the second subframe, a second set of one or more FCB pulses across the time domain and according to the determined second set of FCB pulses; and wherein the generating the FCB signal is further based on the selected second set of FCB pulses.

5. The method of claim 1, wherein the rate distortion criteria is based on a respective subframe.

6. The method of claim 1, wherein the audio encoder comprises a codebook excited linear prediction (CELP) encoder.

7. The method of claim 1, wherein the rate distortion criteria comprises:
$$Max [ Energy ( FCB ) / Energy ( Target ) - {Slope}_{RD} * Number\_of \_Pulses ] ,$$
wherein Energy(FCB) comprises an energy value of a FCB signal contribution for a number of pulses in the subframe, Energy(Target) comprises an energy value for a linear predictive coding (LPC) signal corresponding to the audio signal, Slope_{RD} comprises a rate-distortion parameter, and Number_of_Pulses comprises the determined number of pulses.

8. The method of claim 7, wherein the Slope_{RD} further comprises:
$${slope}_{RD} = const \cdot {( \frac{Smooth ( resnrg )}{resnrg} )}^{a}$$
wherein const comprises a target bitrate for the subframe, resnrg comprises an energy value for a whitened residual speech of the subframe, Smooth( ) comprises an autoregressive smoother, and a comprises a numerical factor.

9. A method comprising:
receiving, by an audio encoder, an audio signal comprising a plurality of subframes;
selecting a first location for a first pulse of a first subframe of the plurality of subframes;
determining k number of pulse candidates, wherein each pulse candidate comprises a plurality of pulse locations for the pulse of the first subframe;
selecting a first location for a second pulse of the first subframe;
determining, for each of the k number of first pulse candidates, l number of pulse locations for the first pulse and the second pulse, thereby resulting in m number of pulse candidates;
selecting a desired pulse candidate from the m number of pulse candidates; and
generating a FCB signal according to the selected desired pulse candidate.

10. The method of claim 9, further comprising:
selecting k number of new pulse candidates from the m number of pulse candidates, wherein the desired pulse candidate is selected from the k number of new pulse candidates.

11. The method of claim 10, wherein the k number of new pulse candidates are selected according to weighted error scores for the respective m number of pulse candidates.

12. The method of claim 9, wherein the desired pulse candidate is selected according to a weighted error score for the desired pulse candidate.

13. The method of claim 9, further comprising:
sending the FCB signal to a decoder.

14. The method of claim 9, wherein the/number of pulse locations for the first pulse and the second pulse comprise k number of pulse locations for the first pulse and the second pulse, and wherein the m number of pulse candidates comprises k² number of pulse candidates.

15. A method comprising:
receiving, by an audio encoder, an audio signal comprising a plurality of subframes;
generating a plurality of pulse candidates, wherein each pulse candidate comprises a plurality of pulse locations for one or more pulses of the first subframe;
determining a first pulse candidate of the plurality of pulse candidates comprises a signal signature value of a second pulse candidate of the plurality of pulse candidates; and
removing either the first pulse candidate or the second pulse candidate from the plurality of pulse candidates.

16. The method of claim 15, further comprising:
assigning a representative value to each respective pulse of the plurality of pulse locations for the first pulse candidate and the second pulse candidate.

17. The method of claim 16, wherein the representative value comprises an integer value.

18. The method of claim 16, further comprising:
combining representative values of the plurality of pulse locations for the first pulse candidate to form a combined first value;
combining representative values of the plurality of pulse locations for the second pulse candidate to form a combined second value; and
wherein the determining further comprises comparing the combined first value to the combined second value.

19. The method of claim 15, further comprising:
generating a fixed codebook (FCB) signal from the plurality of pulse candidates.

20. The method of claim 19, further comprising:
sending the FCB signal to an audio decoder.
